(19) United States
(12) Patent Application Publication
(10) Pub. No.: US 2012/0035756 A1
(43) Pub. Date: Feb. 9, 2012

(54) POST CURE TIRE SIPING FOR PREVENTING IRREGULAR WEAR

(75) Inventors: Stefan Voss, Greer, SC (US); Panning Nathan Joel, Simpsonville, SC (US)

(73) Assignees: SOCIETE DE TECHNOLOGIE MICHELIN, Clermont-Ferrand (FR); MICHELIN RECHERCHE ET TECHNIQUE S.A., Granges-Paccot (CH)

(21) Appl. No.: 13/204,895

(22) Filed: Aug. 8, 2011

Related U.S. Application Data
(60) Provisional application No. 61/371,785, filed on Aug. 9, 2010.

(51) Int. Cl. G06F 17/50; B29C 59/16; B29C 35/08

(52) U.S. Cl. 700/98; 264/400; 264/40.1; 703/1

(57) ABSTRACT

Tires in use wear in a host of ways. One negative manner in which tires, especially truck tires, may wear is in an irregular fashion. When this phenomenon happens, the tread of the tire may become unusable, forcing the user to replace the tire, which is undesirable. This patent application poses a new and useful way of preventing irregular wear involving the addition of a predetermined configuration of pipes, increasing the useful life of the tire tread.

### PRIORITY CLAIM

This application claims the benefit of previously filed U.S. Provisional Patent Application entitled “Post Cure Tire Siping for Preventing Irregular Wear”, assigned U.S. Ser. No. 61/371,785, filed Aug. 9, 2010, and which is incorporated herein by reference in its entirety for all purposes.

### BACKGROUND OF THE INVENTION

1. Field of the Invention

Tires in use wear in a host of ways. One negative manner in which tires, especially truck tires, may wear is in an irregular fashion. When this phenomenon happens, the tread of the tire may become unusable, forcing the user to replace the tire, which is undesirable. This patent application poses a new and useful way of preventing irregular wear involving the addition of a predetermined configuration of sipes, increasing the useful life of the tire tread.

2. Description of the Related Art

Many nominally ribbed tires, such as truck steer and trailer tires for example are subject to irregular wear, which is often characterized by local depressions. Irregular wear is a frequent cause for tires to be removed from service. Accordingly, several design features have been used in the prior art to help prevent irregular wear including microsiping in the outside or shoulder areas of the ribs, providing sipes that are directionally oriented and providing for sacrificial shoulder ribs.

Yet another example of a technique used to prevent, irregular wear is shown by U.S. Pat. No. 4,986,325. It discloses the use of angled grooves and sipes that are strategically positioned and sized for improving wet traction. However, this patent also suggests that placing sipes outside the center region of the tread, which constitutes the middle 80% of the width of the tread, is disadvantageous because such placement increases the risk of heel and toe wear developing in the outer 20% of the tread found on either side of the center region of the tread, which corresponds to the shoulder regions of the tread. In particular, it recommends that sipes should not even extend partially into the shoulder regions of a tread for fear of increasing the risk of heel and toe wear (see col. 6, lines 54-59 of the '325 patent).

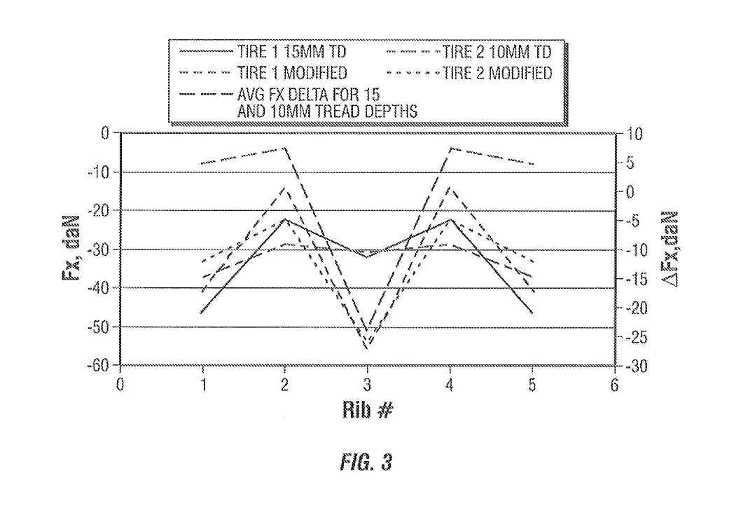

Another method for preventing abnormal wear is disclosed by U.S. Pat. No. 5,316,062. It suggests using sipes having different depths in the tread of tire. Specifically, it teaches decreasing the depth of the sipes such that sipes nearer the center of the tire are deeper than sipes found nearer the shoulders of the tire (see FIGS. 2 and 3 of the '062 patent).

All of these solutions found in the prior art address the need to slow down the development of irregular wear when the tire is first put into service but do little to prevent the development of irregular wear as the tire tread wears past these features. Also, they do not prevent traction losses over the life of the tire tread that occurs especially as sipes are worn away. Lastly, they do not provide a way to modify a tire should some form of testing, modeling or other diagnostic method suggest that the tire could be prone to developing irregular wear.

Accordingly, there still exists a need to prevent irregular wear by modifying new and used tires in such a fashion that they are less prone to irregular wear or other forms of undesirable wear. A method for predicting whether cured tires are prone to develop these types of wear would also be useful so that the tires could be altered to reduce this risk as well.

### SUMMARY OF THE INVENTION

The present invention includes a method for improving the wear performance of a tire comprising the following steps: diagnosing a tendency of the tire to wear improperly, determining a siping configuration that will alleviate the tendency to wear improperly, and applying said siping configuration to the tire.

In some cases, this method is applied to a ribbed tire. In such a case, ribs that are diagnosed as having positive or driving longitudinal or circumferential forces may be siped to reduce the longitudinal forces they experience which in turn increases the longitudinal or circumferential forces that other ribs experience. In other cases, sipes are added to all of the ribs but more sipes and/or deeper sipes are added to the ribs that initially experience positive longitudinal forces.

In other cases, this method is applied to a tire having tread blocks.

In some cases, the step of diagnosing a tendency to wear improperly includes taking contact force measurements. In other cases, the diagnosing step includes looking at the footprint shape. In still other cases, the diagnosing step includes looking at the behavior of the tire as observed in the field.

In some cases, said siping configuration that is added to the tire includes adding sipes to tread blocks and/or tread ribs. In still other cases, said siping configuration that is added to the tire includes angling the sipes to provide directionality.

In some cases, the sipes are spaced approximately 5 mm from each other in the longitudinal or circumferential direction of the tire. In other cases, the sipes are spaced 3-4 mm away from each other in the longitudinal or circumferential direction of the tire.

In some embodiments, the step of adding the siping configuration includes using a mechanical slitting machine. In other embodiments, the step of adding the siping configuration includes using a laser. In still other embodiments, the step of adding the siping configuration includes using some other ablation technique.

In some cases, the method is applied to a heavy, truck tire. In other cases it is applied to a passenger or light truck tire. In yet other cases, the method is applied to a worn tire. Sometimes, the method is applied, to a tread that is attached or will be attached to a tire carcass during a retread operation.

The present invention also includes a method for manufacturing a tire including the following steps: providing a casing or carcass that has a predetermined or measured longitudinal or circumferential force (Fx) profile, and providing a tread that has a predetermined or measured longitudinal or circumferential force (Fx) profile, calculating the longitudinal or circumferential force (Fx) profile of a tire that has said carcass and said tread, comparing the calculated longitudinal force or circumferential force (Fx) profile with a desired longitudinal force or circumferential force (Fx) profile, computing a siping configuration that when added to the tread will create a tire that has the desired longitudinal force or circumferential force (Fx) profile, and adding said computed siping configuration to the tread.

Another Method for modifying an existing tire including the following steps: observing a wear pattern on a tire, computing a siping configuration that when added to the tread will create a tire that has the desired longitudinal force or circumferential force (Fx) profile, and adding said computed siping configuration to the tread.

In some cases, the siping configuration includes adding sipes that are generally oriented in the axial direction of the tire. In other embodiments, the siping configuration includes adding sipes that are oriented in the longitudinal or circumferential direction of the tire. In still other cases, the siping configuration can vary both axially or circumferentially. For example, this could correct wear problems associated with uniformity.

This method may further comprise creating a plurality of tire carcasses whose longitudinal force or circumferential force (Fx) profiles are known and a plurality of treads whose longitudinal force or circumferential force (Fx) profiles are known and determining the sipe configuration that should be added to the tread to create a final tire that has a desired longitudinal force or circumferential force (Fx) profile. For example, the sipes could be added to areas the tire designer predicts will experience strongly positive or driving Fx forces.

Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### DETAILED DESCRIPTION OF THE DRAWINGS

A full and enabling disclosure of the present subject matter, including the best mode thereof, directed to one of ordinary skill in the art, is set forth in the specification, which makes reference to the appended figures, in which:

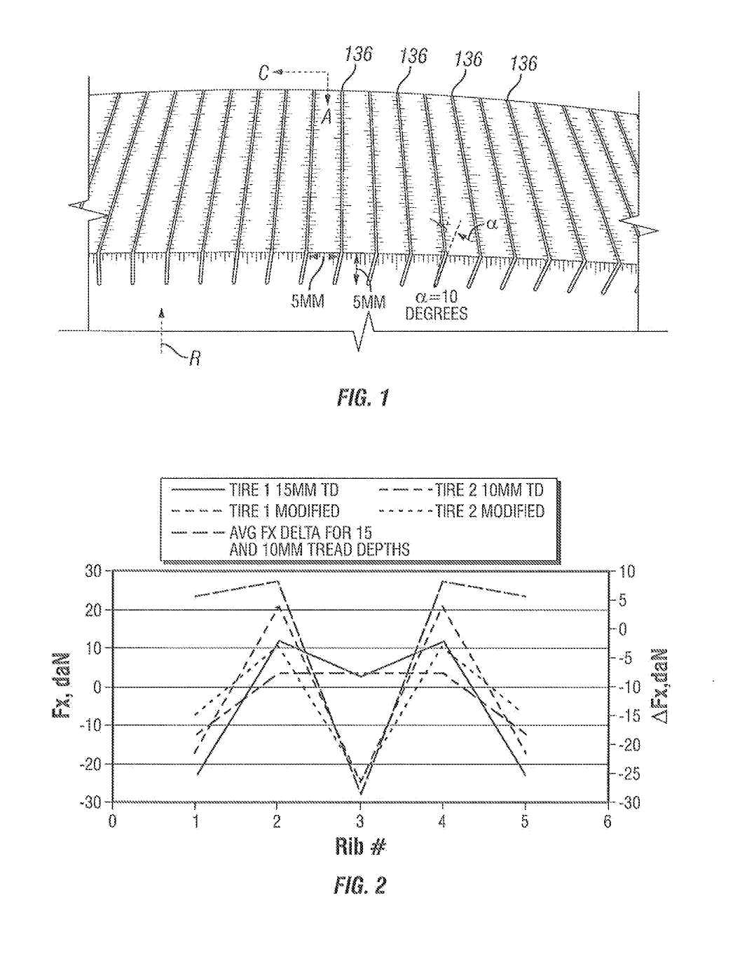

FIG. 1 is a perspective view of a rib of a tire sample with slits that approximate the effect of post curing siping according to one embodiment of the present invention to illustrate the utility of the present invention.

FIG. 2 is a graph showing the change of circumferential/longitudinal or Fx forces for various tire ribs on a tire sample when the tire had a 15 mm tread depth and no added sipes, when the tire had a 15 mm tread depth, and added sipes, when the tire had a 10 mm tread depth and no sipes, when the tire had a 10 mm tread depth and added sipes, and the average change in circumferential or Fx forces when the sample is subjected to essentially no driving/accelerating or braking/decelerating force.

FIG. 3 is a graph showing the change of circumferential/longitudinal or Fx forces for various tire ribs on a tire sample when the tire had a 15 mm tread depth and no added sipes, when the tire had a 15 mm tread depth and added sipes, when the tire had a 10 mm tread depth and no sipes, when the tire had a 10 mm tread depth and added sipes, and the average change in circumferential or Fx forces when the sample is subjected to a braking or decelerating force.

### DETAILED DESCRIPTION OF THE REPRESENTATIVE EMBODIMENTS

Reference will now be made in detail to embodiments of the invention, one or more examples of which are illustrated in the Figures. Each example is provided by way of explanation of the invention, and not meant as a limitation of the invention. For example, features illustrated or described as part of one embodiment can be used with another embodiment to yield still a third embodiment. It is intended that the present invention include these and other modifications and variations. It should be noted that for the purposes of discussion, only a part of the exemplary tire embodiments may be depicted in one or more of the figures. Reference numbers are used in the Figures solely to aid the reader in identifying the various elements and are not intended to introduce any limiting distinctions among the embodiments. Common or similar numbering for one embodiment indicates a similar element in the other embodiments. One of ordinary skill in the art, using the teachings disclosed herein, will understand that the same or substantially similar features can be used on pneumatic, non-pneumatic and hybrid tires or treads alike.

The inventors originally theorized that adding slits or sipes 136 to a tire could alter the longitudinal compliance of the tire, which could reduce the likelihood that the tire would develop irregular wear or wear otherwise in an undesirable manner. In other words, it is desirable to optimize the contact patch longitudinal force distribution (Fx) in order to have an acceptable irregular wear performance or other wear performance and adding slits can contribute to this optimization. This optimized solution depends partly on the overall tire design, as well as the tire application. Some-tires are built that are not optimized for their intended or unintended application, leading to poor irregular wear performance.

Opportunities for making such an adjustment could be based on contact force measurements using tire testing equipment using a force transducer as is commonly known in the art, the footprint shape, the behavior of the tire as observed in the field such as the appearance of irregular wear on the tire or some other diagnostic method. (Further discussion of these diagnostic methods as applied to different applications is provided below.) In some instances, the design of these tires can be “corrected” via internal architecture modifications, in other situations a new mold is required. In either case, these solutions do not address tires that have been already built. Also making a new mold is a costly and time-consuming solution for preventing irregular wear.

Consequently, the inventors found that it is more cost effective for slits 136 to be added to a cured tire if one of the diagnostic methods indicates that the tire is susceptible to irregular wear. These slits could be added using machines known in the art that add sipes for other purposes such as improving traction on a worn tire tread. It is contemplated that siping machines may be altered to provide more flexibility in the sipe geometry that they produce in the treads. For example, the depth and angles of the sipes may be more sophisticated and varied than is currently provided on such machines.

Tire test samples were created in order to test this concept out to see what effect siping could have on preventing irregular wear. FIG. 1 shows an example of a center rib of a tire that defines axial A, circumferential C and radial R directions to which small slits 136 were added to simulate the effect that the present invention would have on preventing irregular wear. The test tire was made by taking a slick or featureless tire and carving five ribs onto it with four straight circumferential grooves, creating a tire with a 15 mm tread depth. The longitudinal forces of the ground on the ribs under rolling conditions were then determined by a test machine using a force transducer by means commonly known in the art for two different scenarios. The first scenario is where the tire is not nominally accelerating or decelerating, or in other words, nominally no driving or braking force is exerted on the tire. The second scenario is when the tire is subjected to a decelerating or braking force.

Next as seen in FIG. 1, slits 136 that were tilted slightly in a positive circumferential direction C or that are extending into the tread in a direction that corresponds to the road direction or the forward rotation of the tire, as indicated by the arrow C, to form an angle α from the radial direction R of the tire of approximately 10 degrees, were added to the center rib, also called rib, # 3. This helps to increase the compliance of the rib, decreasing the longitudinal or Fx forces that the rib experiences. However, inclining the slits 136 is not essential to the present invention. The slits 136 were 5 mm deep and 5 mm apart in the circumferential direction C of the tire. Once again, the longitudinal forces were measured and recorded for the different scenarios described above.

A second tread configuration was built having a tread depth of 10 mm with no sipes. The longitudinal forces on all the ribs were then measured and recorded per the scenarios described above. Lastly, slits that were 5 mm deep and 5 mm apart in the circumferential direction C of the tire were added once more. Finally, the longitudinal forces on all the ribs were then measured and recorded per the scenarios described above. Then all the results were plotted in FIGS. 2 and 3 for the three different scenarios. It should be noted that Fy and Fz, or axial and radial forces remained essentially unchanged for each of the tire configurations and test scenarios.

Looking at FIG. 2, which shows the test results for the various states of the test tire when no accelerating or decelerating force was applied to the tire and vertical load of 1900 kg was applied, it can be seen that modifying the center rib by adding slits 136 had a significant effect on the longitudinal forces on the ribs of the tire. For example, when the tire had no slits and 15 mm tread depth, the longitudinal force on the center rib (rib 3) was slightly positive at 2 daN while ribs to either side of the center rib (ribs 2 and 4) were also slightly positive at approximately 12 daN. After the tire had slits added to the center rib, the longitudinal force on the center rib dropped down to a negative 25 daN approximately while ribs 2 and 4 experienced a longitudinal force increase of 8 daN to a value of 20 daN. So the center rib experienced a tenfold decrease in longitudinal force while ribs 2 and 4 experienced a 50% increase in longitudinal force. Experienced tire designers consider a 5 daN change in longitudinal force on a heavy truck tire or a 3 daN change in longitudinal force on a passenger car or light truck tire to be significant in altering the wear pattern of a tire so these test results indicate that adding sipes is a bona fide way to improve irregular wear.

Looking at the same tire contained in FIG. 2 in a worn stage where the tread depth is 10 mm and the tire is tested with and without slits shows similar results. The longitudinal force exerted on the center went from a positive 2 daN to a negative 25 daN and the longitudinal force exerted on ribs 2 and 4 went from a positive 2 daN to a positive 10 daN. This supports the conclusion that having the hidden tread blocks appear as the tire wears is a viable way of altering the longitudinal force distribution of the tire in a manner that can inhibit the development of irregular wear. This ability to alter the longitudinal force distribution is exemplified by the curve that shows the average change in longitudinal force for the 15 mm and 10 mm tread depths for a siped and unsiped center rib. The change averaged approximately from a positive 5 to 8 daN for ribs 1, 2, 4 and 5 and a negative 28 daN for rib 3, which is significant.

Turning to FIG. 3, the test results for the same configurations of the tire for a scenario where a decelerating force of approximately −160 daN and a vertical load of 1900 kg are applied to a tire are shown. Although the absolute values for the longitudinal (Fx) forces are shifted negatively by approximately 30 daN, which can be attributed mostly to the negative or decelerating force that was exerted on the tire, the overall efficacy of adding slits to alter the longitudinal force distribution of the tire, and therefore affect the development of irregular wear remains. For example, the curve that shows the average change in longitudinal force for the different rib configurations is relatively unchanged.

As can be seen, the addition of slits 136 can help the prevention of irregular wear by increasing The positive longitudinal forces exerted on ribs as it is well known that positive longitudinal force provides some level of protection against irregular wear. Thus, the increase in longitudinal force will provide some irregular wear protection to the non-siped ribs. It is particularly advantageous that the slits can be added as the tire wears and other mechanisms for preventing irregular wear lose their effectiveness, so that irregular wear may be prevented near the end of life of a tire while at the same time traction may be maintained or even enhanced due to the addition of new sipes. Also, the added slits 136 can be added to a new tire as well as a tire that has been used in the field based on the following scenarios.

Given these results, the inventors first considered how ribbed tires such as heavy truck tires could benefit from the addition of slits. One use of this technology involves diagnosing whether the tire may be prone to developing irregular wear based on contact force measurements, footprint shape, the behavior of the tire in the field such as the development of actual irregular wear, or some other diagnostic technique. Then ribs that have driving or positive Fx forces or that do not exhibit irregular wear or other wear problems could have sipes or slits added to them which reduces the. Fx forces on them and increases the Fx forces on the rest of the ribs which might otherwise be braking or have negative Fx forces, making those ribs that were more prone to develop irregular wear less so. This could be done for both new and retread tire applications.

A second use of this technology for ribbed tires involves adding sipes to all the ribs but adding more sipes and/or deeper sipes to certain ribs, usually those that have more positive Fx forces on, exerted on them to increase the Fx forces on those ribs that would be more prone to irregular wear such as those that normally would experience more braking or negative Fx forces. This could be done for both new and retread tire applications.

A third application would be particularly useful for retread applications but could be used for new tires as well and would involve determining the Fx profile of a buffed casing or a casing to which a tire tread has not yet been applied. Then, certain tire treads with predetermined or measured Fx profiles could be added to produce a completed tire with a desired final Fx profile. As can be imagined, different siping or slitting routines could be developed depending on what tire casing is combined with which tire tread to yield a tire that is hot prone to develop irregular wear.

A fourth use would be to cut the sipes or slit at different inclinations relative to the ZY or RA plane to induce X/Z or C/R coupling forces. This directionality can help to increase longitudinal compliance to better decrease the Fx forces exerted on driving ribs so that braking ribs become more positive and less prone to develop irregular wear. See FIG. 1 for an example of this type of directionality.

Second, the inventors considered how this technology could be used on prototype or production tires. As mentioned above, the contact force for each rib of a ribbed tire such as a truck steer or trailer tire for example, may be optimized to improve wear and/or irregular wear performances. For any type of tire, the contact force distribution of the tire may be analyzed and then the tire's contact force distribution can be corrected. For truck steer tires in general whether they have tread blocks or tread ribs, the wear or irregular wear: performances. may be optimized by correcting the contact force distribution, by adding slits or sipes in the appropriate manner.

Also, it is contemplated that this technique allows a single mold to be made that has a knifed number of sipe blades producing a limited number of sipes on tires that can be altered to make a family of similar tires since the addition of sipes and their configuration can be customized easily by properly programming the slitting machine. First, cutting the sipes can save money as molds with sipe blades are very expensive to manufacture. Second, this process allows tires to be prototyped relatively inexpensively as multiple molds with different sipe patterns are no longer required. Third, the density of the sipes can be higher, 3-4 mm for example in the longitudinal direction, which is difficult to achieve with a mold especially with significant amounts of inclination relative to the ZY or RA plane. Fourth, sipes without material removal can be created by the slitting machine and retaining material may enhance a high level of tire rigidity which could be good for other tire performances such as handling and rolling resistance. Fifth, the shape of the slit or sipe could be customized.

Third, the inventors contemplate that this technology may be used on worn tires in various ways including offering it as an after-market service. For example, it could be used on tires which have the onset of irregular wear as an effort to correct the problem and extend the life of the tire. This may be particularly applicable to ribbed tires and may be used to minimize, stop or reverse the propagation of existing irregular wear forms such as local depressions.

Finally, some further refinements to this technology have been contemplated by the inventors. For instance, carving a tire in an appropriate way may extend the life of the tire and may also improve its traction and wear rate. Since traction can be increased by adding the slits as the tire wears and the tread depths is decreased, a rolling resistance improvement can be obtained on such a worn tire due to the decreased mass and hysterisis. Also, this process can be coupled with a tire having a very robust tread since longitudinal compliance can be finely tuned. In addition, the sipes or slits could be added via a laser or other ablation techniques. Also, the direction the sipes or slits are oriented at could be changed. For example, they could be oriented longitudinally, which would make the tire more pliable or forgiving in axial displacement that could be particularly useful on spread axle tire applications.

It should be understood that the present invention includes various other modifications that can be made to the exemplary embodiments described herein that come within the scope of the appended claims and their equivalents. These and other embodiments of the present invention are with the spirit and scope of the claims which follow.

What is claimed is:

1. A method for improving the wear performance of a tire comprising the following steps:
diagnosing a tendency of the tire to wear improperly;
determining a siping configuration that will alleviate the tendency to wear improperly; and
applying said siping configuration to the tire.

2. The method according to claim 1 wherein the tire is a ribbed tire and the ribs that are diagnosed as having positive or driving longitudinal or circumferential forces are siped to reduce the longitudinal forces that said ribs experience which in turn increases the longitudinal forces that the other ribs experience.

3. The Method according to claim 1 wherein the tire is a ribbed tire and sipes are added to all of the ribs but more sipes and/or deeper sipes are added to the ribs that initially experience positive longitudinal forces.

4. The method according to claim 1 wherein the tire has tread blocks.

5. The method according to claim 1 wherein said step of diagnosing a tendency to wear improperly includes taking contact force measurements of the tire.

6. The method according to claim 1 wherein said step of diagnosing a tendency to wear improperly includes looking at the footprint shape of the tire.

7. The method according to claim 1 wherein said step of diagnosing a tendency to wear improperly includes looking at the behavior of the tire as observed in the field.

8. The method according to claim 1 wherein said step of applying a siping configuration includes adding sipes to tread blocks or tread ribs.

9. The method according to claim 1 wherein said step of applying a siping configuration includes angling sipes for providing directionality.

10. The method according to claim 1 wherein said step of applying a siping configuration includes spacing the sipes 3 to 5 mm apart from each other in the longitudinal or circumferential direction.

11. The method according to claim 1 wherein said step of applying a siping configuration includes the use of an ablation technique.

12. The method according to claim 1 wherein said ablation technique involves the use of a mechanical slitting machine or a laser.

13. The method according to claim 1 wherein the tire is a heavy truck tire, a passenger car tire, a light truck tire, a new tire, a worn tire, or a tire that has a tread attached to its carcass or will be attached to its carcass using a retread operation.

14. A method for manufacturing a tire that includes the following steps:
providing a casing or carcass that has a predetermined or measured longitudinal or circumferential force (FX) profile;
providing a tread that has a predetermined or measured longitudinal or cirucmferential force (Fx) profile;
calculating the longitudinal or circumferential force (Fx) profile of a tire that has said carcass and said tread;
comparing the calculated longitudinal force or circumferential force (Fx) profile with a desired longitudinal force or circumferential force (Fx) profile;
computing a siping configuration that when added to the tread will create a tire that has the desired longitudinal force or circumferential force (FX) profile; and
adding said computed siping configuration to the tread.

15. A method for modifying an existing tire comprising the following steps:
observing a wear pattern on a tire;
computing a siping configuration that when added to the tread will create a tire that has the desired longitudinal force or circumferential force (Fx) profile; and
adding said computed siping configuration to the tread.

16. The method according to claim 15 wherein said siping configuration includes adding sipes that are generally oriented in the axial direction of the tire.

17. The method according to claim 15 wherein said siping configuration includes adding sipes that are generally oriented in the longitudinal or circumferential directions of the tire.

18. The method according to claim 15 wherein said siping configuration includes adding sipes that are oriented axially, longitudinally or therebetween.

19. The method according to claim 15 which further comprises the following steps:
creating a plurality of tire carcasses whose longitudinal force or circumferential force (Fx) profiles are known and a plurality of treads whose longitudinal force or circumferential force (Fx) profiles are known; and
determining the sipe configuration that should be added to the tread to create a final tire that has a desired longitudinal force or circumferential force (Fx) profile.
